(19) United States
(12) Patent Application Publication
(10) Pub. No.: US 2017/0291416 A1
(43) Pub. Date: Oct. 12, 2017

(54) INK JET HEAD RECORDING APPARATUS

(71) Applicant: TOSHIBA TEC KABUSHIKI KAISHA, Tokyo (JP)

(72) Inventor: Masashi SEKI, Shimizu Sunto Shizuoka (JP)

(21) Appl. No.: 15/410,412

(22) Filed: Jan. 19, 2017

(30) Foreign Application Priority Data
Apr. 6, 2016 (JP) 2016-076597

(51) Int. Cl. B41J 2/14; B41J 2/165

(52) U.S. Cl. CPC B41J 2/1433; B41J 2/16535

(57) ABSTRACT

An ink jet head recording apparatus comprises an ink jet head that includes a nozzle plate having a plurality of nozzles, a plurality of pressure chambers on an interior side of the nozzle plate and in fluid communication with the plurality of nozzles, an ink supply passage and an ink return passage by which ink is circulated in an out of the pressure chambers, and a coating film formed on an exterior side of the nozzle plate, the coating film having multiple layers in a thickness direction thereof, each layer having liquid repelling regions and lyophilic regions.

### CROSS-REFERENCE TO RELATED APPLICATION

This application is based upon and claims the benefit of priority from Japanese Patent Application No. 2016-076597, filed Apr. 6, 2016, the entire contents of which are incorporated herein by reference.

### FIELD

Embodiments described herein relate generally to an ink jet head recording apparatus.

### BACKGROUND

In an ink jet head recording apparatus that performs image formation by discharging an ink droplet, since ink is discharged from a nozzle as a liquid droplet, surface properties of a nozzle surface have a large effect on the discharge properties of the ink droplet. When the ink becomes adhered to peripheral portions of the nozzle, a discharge direction of the liquid droplet is affected, and defects such as a decrease in the discharge amount of the liquid droplet (the size of the liquid droplet) resulting from a reduction in the nozzle diameter, or instability in a liquid droplet discharge speed, occur. Therefore, the discharge properties of a liquid droplet is generally improved by preventing the adhesion of the ink to a nozzle peripheral portion, e.g., by forming a liquid repelling layer on the nozzle surface. The liquid repelling layer includes a fluororesin, a diamond-like carbon, a non-fluororesin, or the like. The liquid repelling layer has a structure (a liquid repelling structure) that has a liquid repelling property on the surface thereof.

In an ink jet head recording apparatus of the related art, ink that is attached to a nozzle plate surface is removed by wiping using a scraping action of a wiper such as a blade. There is a possibility that the liquid repelling structure of the liquid repelling layer will peel away as a result of the scraping action of the wiper. For example, a fluororesin having an excellent liquid repelling property has a poor scuff property, and therefore, it can be problematic to achieve both the necessary liquid repelling property and scuff property of the liquid repelling layer in a nozzle of an ink jet head. Therefore, there is a possibility that the liquid repelling property of the liquid repelling layer will deteriorate as a result of the scraping action of the wiper during usage for long periods of time.

### DESCRIPTION OF THE DRAWINGS

FIG. 1 is a perspective view that shows a schematic configuration of an ink jet head that is used in an ink jet head recording apparatus according to a first embodiment.

FIG. 2 is an exploded perspective view of the ink jet head.

FIG. 3 is a partial cross-sectional view along a line F3-F3 in FIG. 1.

FIG. 4 is a partial perspective view that shows a portion of the ink jet head.

FIG. 5 is a partial plan view of a nozzle plate of the ink jet head.

FIG. 6 is a cross-sectional view that shows a multi-layered film that is coated onto the nozzle plate of the ink jet head.

FIG. 7A is a cross-sectional view that shows a state of the multi-layered film in which a liquid repelling property is maintained.

FIG. 7B is a cross-sectional view that shows a state of the multi-layered film in which the liquid repelling property is deteriorated.

FIG. 7C is a cross-sectional view that shows a state of the multi-layered film in which the liquid repelling property is restored by peeling away a top layer of the multi-layered coating in which the liquid repelling property is deteriorated.

FIG. 8 is a block diagram that shows a schematic configuration of a cleaning device that cleans the surface of the nozzle plate of the ink jet head.

FIG. 9 is a partial plan view that shows a modification example of the nozzle plate of the ink jet head.

### DETAILED DESCRIPTION

According to the embodiment, there is provided an ink jet head recording apparatus that can prevent deterioration of a liquid repelling property of a liquid repelling layer as a result of a scraping action of a wiper.

According to an aspect of the embodiment, an ink jet head recording apparatus comprises an ink jet head that includes a nozzle plate having a plurality of nozzles, a plurality of pressure chambers on an interior side of the nozzle plate and in fluid communication with the plurality of nozzles, an ink supply passage and an ink return passage by which ink is circulated in an out of the pressure chambers, and a coating film formed on an exterior side of the nozzle plate, the coating film having multiple layers in a thickness direction thereof, each layer having liquid repelling regions and lyophilic regions.

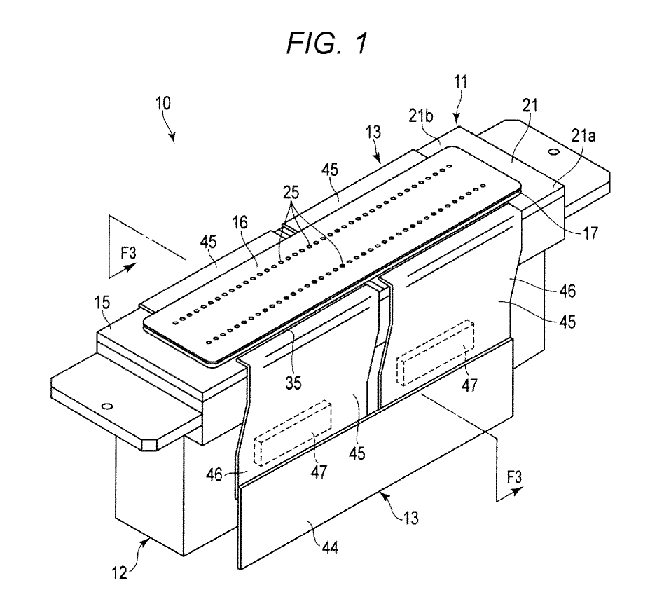

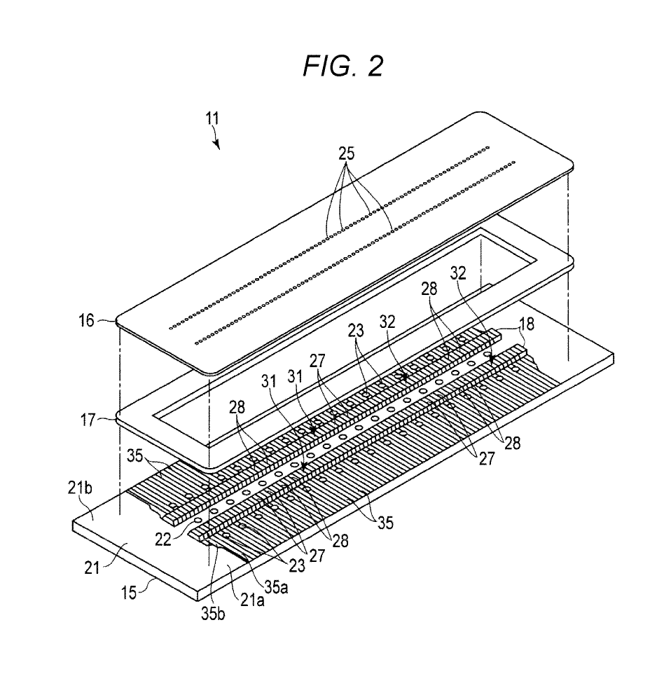

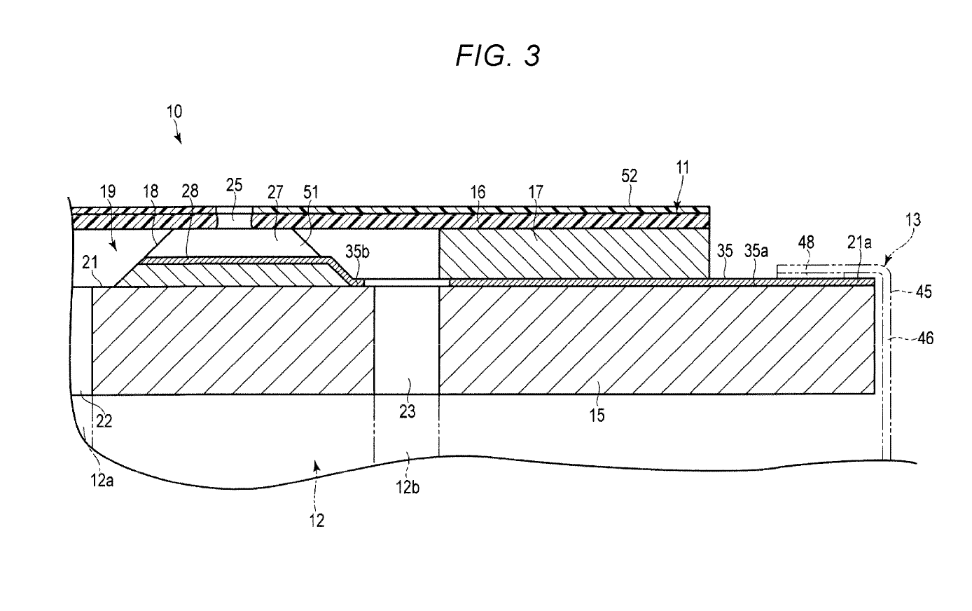

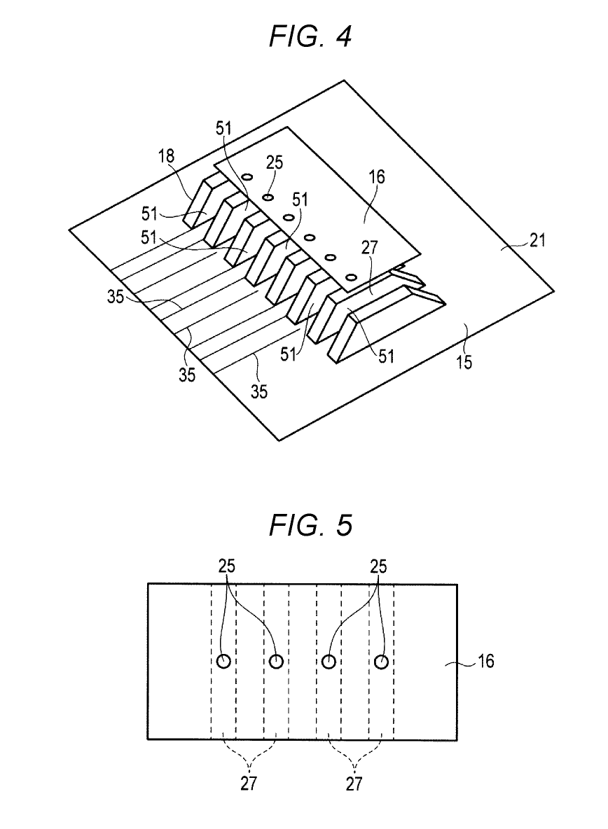

Hereinafter, an embodiment will be described with reference to FIGS. 1 to 7C. FIG. 1 is a perspective view that shows an ink jet head 10 that is used in an ink jet head recording apparatus according to an embodiment. FIG. 2 is an exploded perspective view of the ink jet head 10. FIG. 3 is a partial cross-sectional view along a line F3-F3 in FIG. 1. FIG. 4 is a partial perspective view that shows a portion of the ink jet head.

As shown in FIG. 1, the ink jet head 10 is a so-called side shooter type ink jet head. The ink jet head 10 is mounted in an ink jet printer, and is connected to an ink tank via a component such as a tube. This kind of ink jet head 10 is provided with a head main body 11, a unit portion 12, and a pair of circuit boards 13.

The head main body 11 discharges ink. The head main body 11 is attached to the unit portion 12. The unit portion 12 includes a manifold that forms a portion of a pathway of the ink between the head main body 11 and the ink tank, and a member for being attached to the inner portion of the ink jet printer. The pair of circuit boards 13 are each separately attached to the head main body 11.

As shown in FIG. 3, the head main body 11 includes a base plate 15, a nozzle plate 16, a frame member 17, and a pair of driving elements 18 (only one of the elements 18 is shown in FIG. 3). The base plate 15 is an example of a base material. An ink chamber 19, to which ink is supplied, is formed in the inner portion of the head main body 11.

The base plate 15 is formed in a rectangular plate shape of a ceramic material such as alumina, for example. The base plate 15 includes a flat mounting surface 21. A plurality of supply holes 22, and a plurality of return holes 23 are formed in the mounting surface 21.

The supply holes 22 are provided in the central portion of the base plate 15 and aligned in the longitudinal direction of the base plate 15. As shown in FIG. 3, the supply holes 22 are in communication with an ink supply portion 12a of the manifold of the unit portion 12. The supply holes 22 are connected to the ink tank via the ink supply portion 12a . The ink in the ink tank is supplied to the ink chamber 19 through the supply holes 22.

As shown in FIG. 2, the return holes 23 are arranged in two rows with the supply holes 22 interposed therebetween. As shown in FIG. 3, the return holes 23 are in communication with an ink return portion 12b of the manifold of the unit portion 12. The return holes 23 are connected to the ink tank via the ink ejection portion 12b. The ink of the ink chamber 19 is collected to the ink tank from the return holes 23. In this manner, the ink is circulated between the ink tank and the ink chamber 19.

The nozzle plate 16 is formed using a rectangular film made of a polyimide in which, for example, the surface has a liquid repelling function as described below. The nozzle plate 16 faces the mounting surface 21 of the base plate 15. A plurality of nozzles 25 are formed in the nozzle plate 16. The plurality of nozzles 25 are arranged in two rows along the longitudinal direction of the nozzle plate 16.

The frame member 17 is formed in a rectangular frame shape of a nickel alloy, for example. The frame member 17 is interposed between the mounting surface 21 of the base plate 15 and the nozzle plate 16. The frame member 17 is bonded to each of the mounting surface 21 and the nozzle plate 16. That is, the nozzle plate 16 is attached to the base plate 15 via the frame member 17. The ink chamber 19 is surrounded by the base plate 15, the nozzle plate 16 and the frame member 17.

The driving elements 18 are formed using two plate-shaped piezoelectric bodies formed of lead zirconate titanate (PZT), for example. The two piezoelectric bodies are bonded together so that the directions of polarization thereof are mutually reversed in the thickness direction thereof.

The pair of driving elements 18 are bonded to the mounting surface 21 of the base plate 15. The pair of driving elements 18 are arranged in parallel in the ink chamber 19 to correspond to the nozzles 25 that are aligned in two rows. As shown in FIG. 3, the driving elements 18 are formed to have a trapezoidal shape in cross-section. The top portions of the driving elements 18 are bonded to the nozzle plate 16.

A plurality of grooves 27 are formed in the driving elements 18. The grooves 27 respectively extend in a direction that intersects the longitudinal direction of the driving elements 18, and are arranged along the longitudinal direction of the driving elements 18. As shown in FIG. 5, the plurality of grooves 27 face the plurality of nozzles 25 of the nozzle plate 16. As shown in FIG. 4, in the driving elements 18 according to the present embodiment, a plurality of pressure chambers 51, which correspond to driving flow channels that discharge the ink, are arranged in the grooves 27.

Electrodes 28 are provided in each of the grooves 27. For example, the electrodes 28 are formed by carrying out a photoresist etching process on a nickel thin film. The electrodes 28 cover the inner surfaces of the grooves 27.

As shown in FIG. 2, a plurality of wiring patterns 35 are provided throughout the mounting surface 21 of the base plate 15 and connect to the driving elements 18. For example, these wiring patterns 35 are formed by carrying out a photoresist etching process on a nickel thin film.

The wiring patterns 35 extend from each of one side end portion 21a and the other side end portion 21b of the mounting surface 21. Additionally, in addition to the edges of the mounting surface 21, the side end portions 21a and 21b also include peripheral regions of the edges of the mounting surface 21. Therefore, the wiring patterns 35 may be provided further on the inner side than the edges of the mounting surface 21.

Hereinafter, the wiring pattern 35 that extends from the one side end portion 21a will be described as a representative example. Additionally, the fundamental configuration of the wiring pattern 35 of the other side end portion 21b is the same as that of the wiring pattern 35 of the one side end portion 21a.

The wiring pattern 35 includes a first section 35a and a second section 35b . As shown in FIG. 3, the first section 35a of the wiring pattern 35 extends in a linear manner from the side end portion 21a of the mounting surface 21 toward the driving element 18. The first sections 35a extend in parallel to one another. The second section 35b of the wiring pattern 35 is between the end portion of the first section 35a and the electrode 28. The second sections 35b are respectively electrically connected to the electrodes 28.

In a single driving element 18, several electrodes 28 among the plurality of electrodes 28 configure a first electrode group 31. Other several electrodes 28 among the plurality of electrodes 28 configure a second electrode group 32.

The first electrode group 31 and the second electrode group 32 are divided with the central portion in the longitudinal direction of the driving element 18 as a boundary. The second electrode group 32 is adjacent to the first electrode group 31. For example, the first and second electrode groups 31 and 32 respectively include 159 electrodes 28.

As shown in FIG. 1, the pair of circuit boards 13 respectively includes a substrate main body 44, and a pair of film carrier packages (FCPs) 45. Additionally, the FCPs is also be referred to as tape carrier packages (TCPs).

The substrate main body 44 is a rigid printed circuit board that is formed in a rectangular shape. Various electronic components and connectors are mounted on the substrate main body 44. In addition, the pair of FCPs 45 are attached to the substrate main body 44.

The pair of FCPs 45 respectively includes a flexible resin film 46 in which a plurality of pieces of wiring are formed, and an IC 47 that is connected to the plurality of pieces of wiring. The film 46 is a tape automated bonding (TAB) tape. The IC 47 is a component for applying a voltage to the electrodes 28. The IC 47 is fixed to the film 46 using a resin.

As shown in FIG. 3, the end portion of one FCP 45 is connected to the first section 35a of the first wiring pattern by thermocompression bonding using an anisotropic conductive film (ACF) 48. The end portion of the other FCP 45 is connected to a first section 36a of a second wiring pattern 36 by thermocompression bonding using an ACF 48. As a result of this, the plurality of pieces of wiring of the FCPs 45 are electrically connected to the first and second wiring patterns 35 and 36.

As a result of the FCPs 45 being connected to the first and second wiring patterns 35 and 36, the ICs 47 are electrically connected to the electrodes 28 via the wiring of the FCPs 45. The ICs 47 apply a voltage to the electrodes 28 via the wiring of the films 46.

When the ICs 47 apply the voltage to the electrodes 28, the volume of the grooves 27 in which the corresponding electrodes 28 are provided, fluctuate as a result of the driving elements 18 deforming in a shear mode. As a result of this, the pressure of the ink inside the grooves 27 changes, and the corresponding ink is discharged from the nozzles 25.

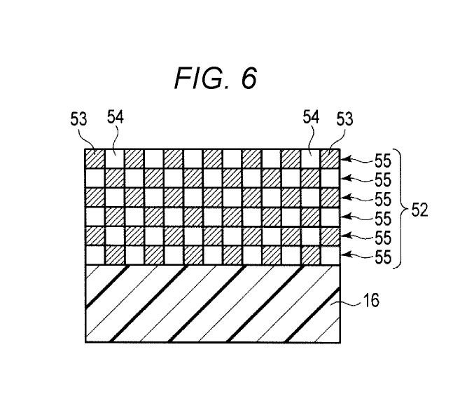

In addition, in the present embodiment, as shown in FIG. 3, a multi-layered coating 52, which achieves a liquid repelling function, is formed on a liquid droplet discharge direction surface (the upper surface of the nozzle plate 16 in FIG. 3) of the nozzle plate 16. As shown in FIG. 6, the multi-layered coating 52 is a component in which a plurality of layers (six layers in the present embodiment) of coating films 55, which are coated in a state in which liquid repelling regions 53 that have a liquid repelling property and lyophilic regions 54 that have a lyophilic property are arranged in a dispersed manner within a single planar surface, are laminated in the thickness direction.

Next, the multi-layered coating 52 having the above-mentioned configuration will be described. For example, the multi-layered coating 52 uses the “water and oil repelling material” disclosed in JP-A-2015-44983 as the coating film 55. In the coating film 55, the lyophilic regions 54 are formed in a dispersed manner on the outermost surface of the liquid repelling regions 53. In the water and oil repelling material, the lyophilic regions 54 are dispersed in the liquid repelling regions 53. It is possible to produce the water and oil repelling material by mixing a hydrophilic composition with a water repellent composition at an appropriate ratio. The mixing ratio of the hydrophilic composition maybe 50% or less with respect to the water repellent composition. However, it is necessary to perform mixing so that at least the area of the lyophilic regions 54 correspond to 2% or more on the surface of the water and oil repelling material.

In the present embodiment, a single layer of the coating film 55, in which the lyophilic regions 54 and the liquid repelling regions 53 are present in a dispersed manner on the outermost surface, is formed as a result of coating the upper surface of the nozzle plate 16 with the coating film 55 of the water and oil repelling material. As shown in FIG. 6, the multi-layered coating 52, in which a plurality of layers of the coating film 55 are laminated, is formed by repeating the work of coating with the coating film 55 a plurality of times.

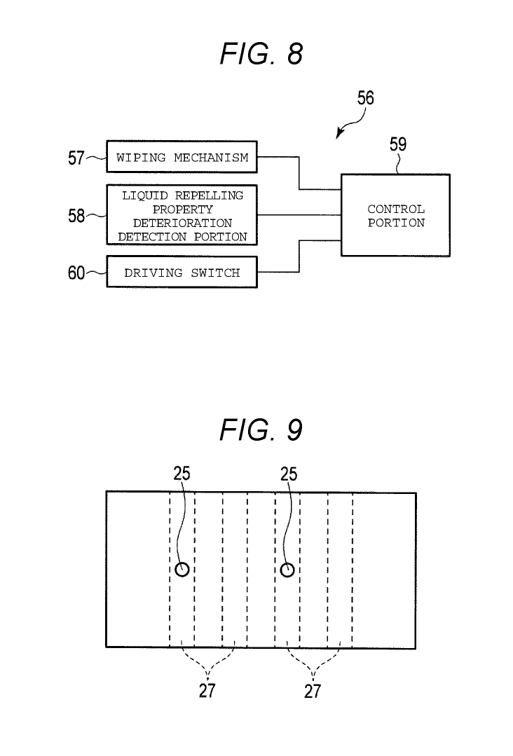

In addition, as shown in FIG. 8, the ink jet head recording apparatus according to the present embodiment includes a cleaning device 56 that cleans the surface of the nozzle plate 16. FIG. 8 is a block diagram that shows a schematic configuration of a cleaning device 56 that cleans the surface of the nozzle plate 16 of the ink jet head 10. The cleaning device 56 includes a wiping mechanism 57, a liquid repelling property deterioration detection portion 58, a control portion 59, and a driving switch 60.

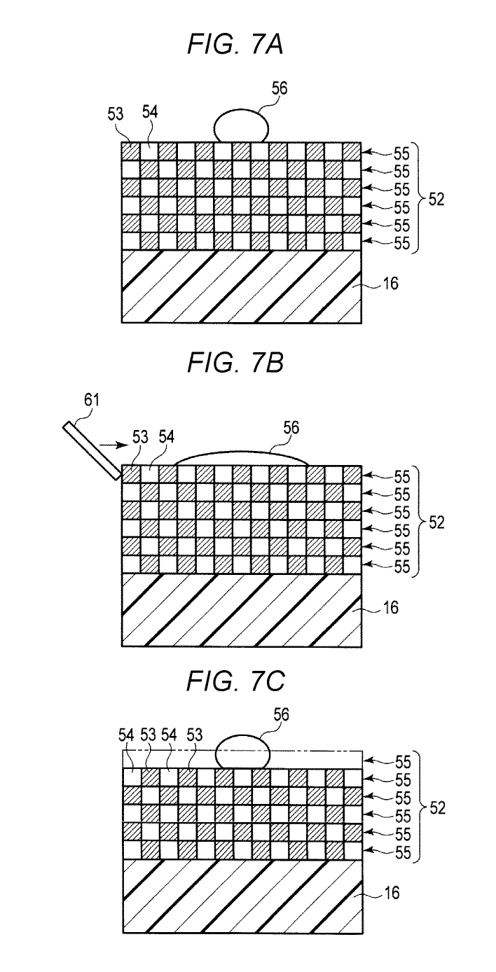

In this instance, for example, the wiping mechanism 57 includes a wiper 61 (refer to FIG. 7B) such as a blade that contacting with and separating from the surface of the nozzle plate 16. The liquid repelling property deterioration detection portion 58 is a logic device, e.g., a processor, programmed to detect a staining condition of the surface of the nozzle plate 16. For example, the liquid repelling property deterioration detection portion 58 can use a counter that counts the number of used sheets of a paper medium, or the like, on which printing is performed by the ink jet head recording apparatus, or can use data of, for example, a timer that tracks an elapsed time since use. Further, for example, deterioration of the liquid repelling property of the nozzle plate 16 is determined, i.e., that the surface of the nozzle plate 16 is stained, when a count number of used sheets of the paper medium, or the like, or a measured value of the elapsed time since use exceeds a settings value that is established in advance.

The driving switch 60 which drives the wiping mechanism 57, and the liquid repelling property deterioration detection portion 58 are connected to the control portion 59, e.g., a controller. Further, in the control portion 59, the wiping mechanism 57 is driven when the driving switch 60 is operated so as to be on, and when a stained condition of the surface of the nozzle plate 16 is detected by the liquid repelling property deterioration detection portion 58. The wiping mechanism 57 is maintained at a standby position in a non-active state during normal use of the ink jet head recording apparatus.

In addition, during driving of the wiping mechanism 57, the wiper 61 is moved from the standby position to a use position based on a control signal from the control portion 59. At this time, as shown in FIG. 7B, the wiper 61 is caused to abut against the coating film 55 that is the outermost surface of the multi-layered coating 52 on the nozzle plate 16. In this state, the wiper 61 is slid along the surface of the coating film 55 of the nozzle plate 16 based on a control signal from the control portion 59. At this time, the coating film 55 that is the outermost surface of the multi-layered coating 52 is peeled away by the wiping action (the scraping action) of the wiper 61. As shown in FIG. 7C, a new coating film 55 of a second layer is exposed at the outermost surface of the multi-layered coating 52 as a result of peeling away the coating film 55 that is the outermost surface of the multi-layered coating 52, the liquid repelling property of which is deteriorated, using the wiping action of the wiper 61. As a result of this, staining of the upper surface of the nozzle plate 16 is removed.

Next, an example of an action of the ink jet head recording apparatus including the nozzle plate 16 on which the multi-layered coating 52 having the above-mentioned configuration is coated, will be described with reference to FIGS. 7A to 7C. With respect to the nozzle plate 16, in an initial period after the start of use of the ink jet head recording apparatus, ink 62 is prevented from being adhered to the peripheral portions of the nozzles 25 by the coating film 55 that is the outermost surface of the multi-layered coating 52. FIG. 7A shows a state in which the ink 62 which is scattered in the peripheral portions of the nozzle 25 is repelled by the coating film 55.

As time passes after the start of use of the ink jet head recording apparatus, the liquid repelling property of the coating film 55 that is the outermost surface of the multi-layered coating 52 gradually decreases. FIG. 7B shows a state in which the liquid repelling property of the coating film 55 is deteriorated. Further, in the above-mentioned manner, the wiping mechanism 57 is driven when a stained state of the surface of the nozzle plate 16 is detected by the liquid repelling property deterioration detection portion 58. At this time, the wiper 61 is slid along the surface of the coating film 55 of the nozzle plate 16, and the coating film 55 that is the outermost surface of the multi-layered coating 52 is peeled away as a result of the wiping action of the wiper 61.

As a result of this, as shown in FIG. 7C, a new coating film 55 of the second layer is exposed at the outermost surface of the multi-layered coating 52. As a result of this, the liquid repelling property of the ink 62 that is scattered in the peripheral portions of the nozzle 25 is restored by the coating film 55 (the new coating film 55 of the second layer) of the outermost surface of the multi-layered coating 52.

Additionally, according to necessity, the coating film 55 that is the outermost surface of the multi-layered coating 52 may be peeled away by driving the wiping mechanism 57 as a result of an ON operation of the driving switch 60 manually. In this case, it is also possible to expose a new coating film 55 at the outermost surface of the multi-layered coating 52. Therefore, it is possible to restore the liquid repelling property of the ink 62 is scattered in the peripheral portions of the nozzles 25.

In the present embodiment, as shown in FIG. 6, the multi-layered coating 52, in which a plurality of layers (six layers in the present embodiment) of the coating films 55, which are coated in a state in which the liquid repelling regions 53 and the lyophilic regions 54 are arranged in a dispersed manner within a single planar surface, are laminated in the thickness direction, is provided on the liquid droplet discharge direction surface of the nozzle plate 16. As a result of this, when the liquid repelling property of the coating film 55 that is the outermost surface of the multi-layered coating 52 deteriorates, it is possible to peel away the deteriorated coating film 55 that is the outermost surface by driving the wiping mechanism 57. At this time, since it is possible to expose a coating film 55, the liquid repelling property of which is not deteriorated, at the outermost surface of the multi-layered coating 52, it is possible to restore the liquid repelling property of the peripheral portions of the nozzles 25. As a result of this, it is possible to prevent the liquid repelling property of the liquid repelling layer from deteriorating due to the scraping action of the wiper 61. Therefore, it is possible to maintain liquid droplet discharge properties during use of the inkjet head recording apparatus to be in high-quality.

FIG. 9 is a partial plan view that shows a modification example of the nozzle plate 16 of the ink jet head 10. The present modification example has a configuration in which sections of the nozzle plate 16 in which the nozzles 25 are correspondingly formed, and sections (sections without nozzle) of the nozzle plate 16 in which the nozzles 25 are not formed, are arranged with respect to the plurality of grooves 27 of the driving elements 18 in every other groove 27. Additionally, the plurality of nozzles 25 maybe arranged with aligned in a staggered manner. The multi-layered coating 52 that achieves a liquid repelling function having the same configuration as that of the first embodiment is also formed on the liquid droplet discharge direction surface of the nozzle plate 16 of the present modification example.

According to the configuration of the present modification example, a coating film 55 having a new liquid repelling structure is revealed even if the deteriorated coating film 55 that is the outermost surface of the multi-layered coating 52 of the surface of the nozzle plate 16 is peeled away as a result of driving the wiping mechanism 57. As a result of this, since the liquid repelling property of the coating film 55 that is the outermost surface of the nozzle plate 16 does not deteriorate even if the ink 62 that is adhered to the surface of the nozzle plate 16 is removed, it is possible to prevent discharge faults such as curved flight of the liquid droplets that are discharged from the nozzles 25.

According to these embodiments, it is possible to provide an inkjet head recording apparatus that can prevent the liquid repelling property of the liquid repelling layer from deteriorating as a result of wiping.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ink jet head recording apparatus comprising an ink jet head that includes:
a nozzle plate having a plurality of nozzles;
a plurality of pressure chambers on an interior side of the nozzle plate and in fluid communication with the plurality of nozzles;
an ink supply passage and an ink return passage by which ink is circulated in an out of the pressure chambers; and
a coating film formed on an exterior side of the nozzle plate, the coating film having multiple layers in a thickness direction thereof, each layer having liquid repelling regions and lyophilic regions.

2. The apparatus according to claim 1, wherein the nozzles are aligned in a longitudinal direction of the nozzle plate, and liquid repelling regions and lyophilic regions alternate along the longitudinal direction and a lateral direction of the nozzle plate.

3. The apparatus according to claim 2, wherein the coating film covers an entire exterior surface of the nozzle plate and does not cover the nozzles.

4. The apparatus according to claim 1, wherein the pressure chambers are pressurized to discharge ink through the nozzles.

5. The apparatus according to claim 1, further comprising:
a pair of plate-shaped driving elements arranged on either side of each pressure chamber in the longitudinal direction, each driving element being formed of two piezoelectric bodies that are bonded together.

6. The apparatus according to claim 5, wherein upper ends on the driving elements are bonded to the interior side of the nozzle plate.

7. The apparatus according to claim 6, further comprising:
electrodes that cause the driving elements to deform in a shear mode and change the pressure inside the pressure chambers, when voltage is applied to the electrodes.

8. The apparatus according to claim 1, further comprising:
a wiper blade configured to wipe the exterior side of the nozzle plate;
a processor programmed to determine deterioration of the liquid repelling property in the top layer of the coating film; and
a controller configured to control the wiper blade to remove the top layer of coating film when the detector detects the deterioration of the liquid repelling property in the top layer.

9. The apparatus according to claim 8, wherein the processor is programmed to determine the presence of deterioration when the number of sheets printed by the ink jet head is greater than a threshold number.

10. The apparatus according to claim 8, wherein the processor is programmed to determine the presence of deterioration when the amount of time elapsed since the last wipe of the exterior side of the nozzle plate is greater than a threshold amount of time.

11. An ink jet head comprising:
a nozzle plate having a plurality of nozzles;
a plurality of pressure chambers on an interior side of the nozzle plate and in fluid communication with the plurality of nozzles;
an ink supply passage and an ink return passage by which ink is circulated in an out of the pressure chambers; and
a coating film formed on an exterior side of the nozzle plate, the coating film having multiple layers in a thickness direction thereof, each layer having liquid repelling regions and lyophilic regions.

12. The ink jet head according to claim 11, wherein the nozzles are aligned in a longitudinal direction of the nozzle plate, and liquid repelling regions and lyophilic regions alternate along the longitudinal direction and a lateral direction of the nozzle plate.

13. The ink jet head according to claim 12, wherein the coating film covers an entire exterior surface of the nozzle plate and does not cover the nozzles.

14. The ink jet head according to claim 11, wherein the pressure chambers are pressurized to discharge ink through the nozzles.

15. The ink jet head according to claim 11, further comprising:
a pair of plate-shaped driving elements arranged on either side of each pressure chamber in the longitudinal direction, each driving element being formed of two piezoelectric bodies that are bonded together.

16. The ink jet head according to claim 15, wherein upper ends on the driving elements are bonded to the interior side of the nozzle plate.

17. The ink jet head according to claim 16, further comprising:
electrodes that cause the driving elements to deform in a shear mode and change the pressure inside the pressure chambers, when voltage is applied to the electrodes.

18. A method of restoring liquid repelling property of an exterior side of a nozzle plate of an ink jet head, comprising:
determining deterioration of the liquid repelling property in a top layer of a coating film formed on the exterior side of the nozzle plate and having multiple layers in a thickness direction thereof, each layer having liquid repelling regions and lyophilic regions; and
driving a wiper blade across the exterior side of the nozzle plate to remove the top layer of the coating film and expose a next uppermost layer of the coating film.

19. The method according to claim 18, wherein the deterioration is determined when the number of sheets printed by the ink jet head is greater than a threshold number.

20. The method according to claim 18, wherein the deterioration is determined when the amount of time elapsed since the last wipe of the exterior side of the nozzle plate is greater than a threshold amount of time.
